(19) United States
(12) Patent Application Publication
(10) Pub. No.: US 2012/0135098 A1
(43) Pub. Date: May 31, 2012

(54) Extrusion Mixing Screw and Method of Use

(76) Inventor: Conor James Walsh, Campbell, NY (US)

(21) Appl. No.: 13/296,791

(22) Filed: Nov. 15, 2011

Related U.S. Application Data
(60) Provisional application No. 61/418,169, filed on Nov. 30, 2010.

(51) Int. Cl. B29B 7/80; A21C 11/16; B01F 7/08

(52) U.S. Cl. 425/376.1; 366/83

(57) ABSTRACT

An extruder screw segment has opposed end faces disposed at a non-orthogonal angle with respect to a rotation axis of the body.

### CROSS-REFERENCE TO RELATED APPLICATIONS

This application claims the benefit of priority under 35 U.S.C. §119 of U.S. Provisional Application No. 61/418,169 filed on Nov. 30, 2010, the content of which is relied upon and incorporated herein by reference in its entirety.

### TECHNICAL FIELD

The present invention relates generally to an apparatus for preparation of an extruded body, and more particularly, to ceramic extrusion screws and an extruder using ceramic extrusion screws.

### BACKGROUND

The manufacture of ceramic honeycomb structures by the process of plasticizing ceramic powder batch mixtures, extruding the mixtures through honeycomb extrusion dies to form honeycomb extrudate, and drying and firing the extrudate to produce ceramic honeycombs of high strength and thermal durability, is well known. The ceramic honeycombs thus produced are widely used as ceramic catalyst supports in motor vehicle exhaust systems, and as catalyst supports and wall-flow particulate filters for the removal of soot and other particulates from diesel engine exhausts.

Among the commercially successful processes for ceramic honeycomb manufacture are those that utilize large rotating screw (or co-rotating twin screw) extruders for the mixing and extruding of ceramic honeycomb extrudate. These machines offer the capability of homogenizing and plasticizing ceramic powder batch mixtures and pressure-forcing the mixtures through honeycomb extrusion dies, such as in a single continuous processing operation. The favorable economics of this approach extend from the high-volume production of honeycombs of relatively small diameter for automobile exhaust systems to the shaping of very large frontal area (VLFA) honeycombs for large diesel engine exhaust systems. Cylindrical honeycomb shapes having cross-sectional diameters measured transversely to the cylinder axis and direction of honeycomb channel orientation can range from as small as 5 cm up to 50 cm or more.

The rotating screws used in extruders commonly comprise a plurality of screw segments that are successively positioned, such as on a splined or keyed axial drive shaft, to form the entire screw. Screw segments may be made of any suitable material, such as metal or ceramic. Ceramic screw segments are particularly desirable when extruding ceramic batch mixtures because of several factors. For example, as compared to metal screw segments, ceramic screw segments have a reduced wear rate, which thereby reduces screw segment replacement frequency and increases extruder up-time. Additionally, ceramic screw segments can be provided with an extremely smooth surface finish that enables increased material throughput in the extruder.

One problem attending the use of ceramic screw segments relates to the attachment of the screw segments to the drive shaft of the extruder. The drive shaft is typically metal and, as noted above, is configured with a splined or keyed geometry for preventing rotation of the screw segments about the drive shaft. Metal screw segments are typically configured with a mating splined or keyed geometry. However, due to the brittleness of ceramic materials, ceramic screw segments are generally not directly provided with a splined or keyed geometry, because the splined or keyed ceramic surface will likely result in point loading that may fracture the ceramic material when exposed to the high forces encountered in the extrusion process. Therefore, ceramic screw segments are typically manufactured with a smooth (e.g., circular) axial opening, and a metal collar inserted and bonded (using, e.g., epoxy) into the opening of the ceramic outer geometry. The metal insert is configured to mate with the drive shaft, such as in a splined or keyed engagement. In other embodiments, the ceramic screw segment may be bonded directly to the drive shaft without use of an intermediate metal insert and without use of splined or keyed engagement.

Because of the severe conditions experienced within an extruder during use (e.g., high temperatures, pressures, torque, and the like), the bond at the ceramic-metal interface is subject to failure during use, such as when high temperatures or torques exceed the capabilities of the bonding agent. As can be appreciated, a bond failure can result in equipment damage or lost production time.

### SUMMARY

In one aspect, the disclosure describes a screw set for an extruder having an axially extending drive shaft. The screw set comprises a plurality of screw segments, each screw segment having opposed end faces disposed at a non-orthogonal angle α with respect to a rotational axis of the screw segment; wherein the plurality of screw segments are contiguously positioned on the drive shaft such that end faces of contiguous screw faces align and mate with each other.

In another aspect, the disclosure describes an extruder screw segment comprising a cylindrical body having opposed end faces disposed at a non-orthogonal angle α with respect to a rotation axis of the body.

In yet another aspect, the disclosure describes an extruder. The extruder comprises: a barrel including a chamber and a discharge port; an extrusion molding die coupled with respect to the discharge port of the barrel; and a screw set rotatably mounted at least partially within the chamber. The screw set comprises a plurality of contiguously positioned screw segments, each screw segment having opposed end faces disposed at a non-orthogonal angle α with respect to a rotation axis of the screw set.

It is to be understood that both the foregoing general description and the following detailed description present example and explanatory embodiments that are intended to provide an overview or framework for understanding the nature and character of the invention as it is claimed. The accompanying drawings are included to provide a further understanding of the written description, and are incorporated into and constitute a part of this specification. The drawings illustrate various example embodiments of the claimed invention, and together with the description, serve to explain the principles and operations of the claimed invention.

### BRIEF DESCRIPTION OF THE DRAWINGS

These and other features, aspects and advantages of the present invention are better understood when the following detailed description of the invention is read with reference to the accompanying drawings, in which:

FIG. 1 is a schematic view of an example twin-screw extruder in accordance with aspects of the present invention;

FIG. 2 is a front sectional schematic view taken along line 2-2 of FIG. 1 illustrating an example screw segment in accordance with other aspects of the present invention;

FIGS. 3A-3B provide views of a plurality of screw segments having end faces non-orthogonal to the axial direction, with FIG. 3A showing a side view of the screw segments in a separated condition, FIG. 3B showing a perspective view of the screw segments in a separated condition, and FIG. 3C showing a side view of the screw segments in a joined or mated condition;

FIG. 4 is a side view of screw segments according to embodiments described herein, illustrating various angles of the end faces of the screw segments; and

FIGS. 5A-5B provide views of a plurality of screw segments having pockets in their end faces for receiving a key insert, with FIG. 5A showing a perspective view of the screw segments and insert in a separated condition, FIG. 5B showing a side view of the screw segments and insert in a separated condition, and FIG. 5C showing a side view of the screw segments in a joined or mated condition, with one screw segment ghosted to allow viewing of the insert.

### DETAILED DESCRIPTION

Description of example embodiments will now be provided with reference to the accompanying drawings in which example embodiments are shown. However, the claimed invention may be embodied in many different forms and should not be construed as limited to the exemplary embodiments set forth herein. Like reference numbers refer to like elements throughout the various drawings.

Porous honeycomb articles are known to facilitate filtering of fluid to remove undesirable components. In one example, porous honeycomb articles are known to function as a particulate filter and may or may not include a catalyst layer. Such porous honeycomb filters are useful, for example, to filter exhaust from an engine (e.g., diesel engine) before releasing the exhaust to the environment. Other examples of porous honeycomb articles can include flow-through substrates or other thin-wall bodies.

Porous honeycomb articles can comprise various materials depending on the particular application and substrate characteristics. For instance, the porous honeycomb articles can comprise cordierite, aluminum titanate, silicon carbide, mullite or other materials. In one example, porous cordierite ceramic honeycomb articles can be formed with a wide variety of batch compositions including a quantity of inorganic components. The quantity of inorganic components can include oxide sources of magnesia, alumina and silica effective to form cordierite (Mg₂Al₄Si₅O₁₈) upon firing. Such oxide sources can be provided, for example, by talc, alumina, aluminum hydroxides, clay, and/or silica.

Various ceramic honeycomb articles may be produced with the concepts of the present invention. In one example, the honeycomb articles of the present invention can include cell geometries with a cell density greater than 200 cells/in² (cpsi). In further examples, honeycomb articles of the present invention can include cell geometries with a cell density of greater than about 300 cpsi, such as greater than about 400 cpsi, 500 cpsi, 600 cpsi, 700 cpsi, 800 cpsi, or 900 cpsi. Furthermore, the walls forming the cells are porous and can have a wall thickness of less than 12 mil (305 μm), or even less than or equal to 1 mil (25.4 um).

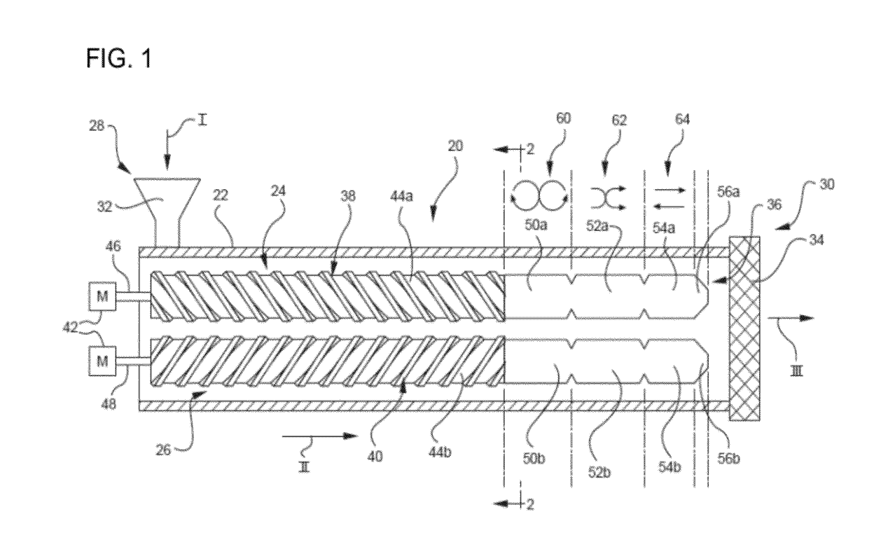

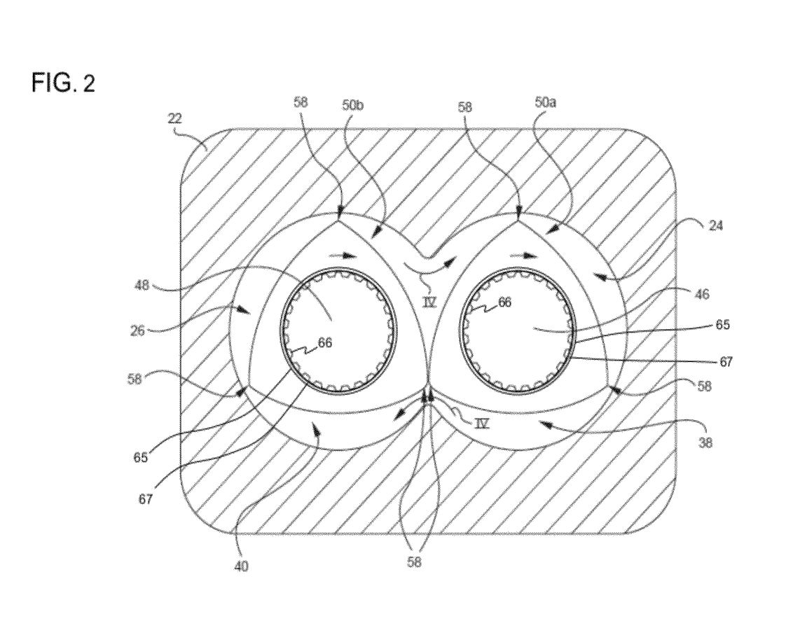

Turning to the example shown in FIG. 1, an example continuous twin-screw extruder 20 is schematically illustrated. The twin-screw extruder 20 includes a barrel 22 including a pair of chambers 24, 26 formed therein and in communication with each other (see also FIG. 2). The barrel 22 can be monolithic, or can be formed from a plurality of barrel segments connected successively in the longitudinal (i.e., axial) direction. The chambers 24, 26 penetrate the barrel 22 in the longitudinal direction from an upstream side 28 to a downstream side 30. At the upstream side 28 of the barrel 22, a material supply port 32, which can include a hopper or other material supply structure, is provided for supplying the batch material to the extruder 20. An extrusion die 34 is provided at a discharge port 36 at the downstream side 30 of the barrel 22 for extruding the batch material into a desired shape, such as honeycomb article or the like. The extrusion die 34 can be coupled with respect to the discharge port 36 of the barrel 22, such as at an end of the barrel 22. The extrusion die 34 can be preceded by other structure, such as a generally open cavity (not shown), screen/homogenizer (not shown), or the like to facilitate the formation of a steady plug-type flow front before the batch reaches the extrusion die 34.

A pair of extruder screw sets 38, 40 is mounted in the barrel 22. As shown, first screw set 38 is rotatably mounted at least partially within one of the chambers 24, while second screw set 40 is rotatably mounted at least partially within the other of the chambers 26. The first and second screw sets 38, 40 can be arranged generally parallel to each other, as shown, though they can also be arranged at various angles relative to each other. The first and second screw sets 38, 40 can also be coupled to a driving mechanism 42 outside of the barrel 22 for rotation in the same, or different, directions. It is to be understood that the both of the first and second screw sets 38, 40 can be coupled to a single driving mechanism 42, or as shown, individual driving mechanisms 42.

As discussed in greater detail below, each of the first and second screw sets 38, 40 include a plurality of screw segments extending along their longitudinal lengths, and each screw segment (or grouping of screw segments) can impart various processes upon the batch located within the barrel 22. Each of the plurality of removable screw segments is connected contiguously in the longitudinal (i.e., axial) direction on a corresponding one of first and second drive shafts 46, 48, having a rotational axis generally aligned with the centers of the respective chambers 24, 26. The first and second drive shafts 46, 48 can have the plurality of screw segments removably coupled thereto in various manners. For example, the removable screw segments can be removably coupled via a spline shaft, keyway structure, etc. In another embodiment, any or all of the removable screw segments can be non-removably coupled to the drive shafts 46, 48, such as by adhesives, welding, etc.

The plurality of screw segments can include various types. For clarity, it is to be understood that similar, such as identical, screw segments of each of the first and second screw sets 38, 40 will have similar reference numbers with respective “a” or “b” designations, with the understanding that any descriptions can apply to both such similar segments. In one example, a pumping screw segment 44a, 44b can be arranged generally towards the upstream side 28 of the extruder 20 for feeding the batch material from the supply port 32 and pumping or pushing the batch material towards the downstream side 30. The pumping screw segments 44a, 44b (as well as other types and designs of screw segments described below) can include various single-flight or multi-flight spiral designs, as desired. Each of the screw segments can be of the meshing type having flights arranged so as to mesh with each other inside the barrel 22. For example, during rotation, one of the pumping screw segments 44a can scrape material off the other pumping screw segments 44b.

Different screw segments 50, 52, 54, 56 may be provided towards the downstream side 30 of the barrel 22 and toward the discharge port 36 to promote a relatively more uniformly mixed and discharged batch material to reduce temperature, shear, and/or composition constituent gradients at the extruder outlet. The types, numbers, and configurations of screw segments can facilitate various types of batch material mixing, such as circumferential mixing (i.e., mixing of the ceramic batch between the pair of chambers 24, 26 of the barrel 22), axial mixing (i.e., mixing of the ceramic batch along the longitudinal axis within each of the pair of chambers 24, 26 of the barrel 22), and/or radial mixing (i.e., mixing a radially-inward portion of the ceramic batch with a radially-outward portion of the ceramic batch). Each type of mixing is illustrated in FIG. 1 with a schematic symbol: circumferential mixing 60; radial mixing 62; and axial mixing 64. Although illustrated in FIG. 1 in one example order, it is to be understood that the various segments 50, 52, 54 can be arranged variously as required to impart the desired characteristics to the batch material.

FIG. 2 is a sectional schematic view taken along line 2-2 of FIG. 1 illustrating an example screw segments 50a, 50b configured to facilitate circumferential mixing 60 of the batch material along the direction of arrows IV (i.e., mixing of the ceramic batch material between the pair of chambers 24, 26 of the barrel 22). Screw segments 44, 50, 52, 54, 56 can include at least one flight element spirally formed about the length of the segment. In other examples (not shown), the screw segments can include a double flight element or a triple-flight element. For example, FIG. 2. illustrates triple-flight elements 58 arranged at generally equal angular intervals of about 120 degrees in the circumferential direction and spirally formed about the length of the segments 50a, 50b.

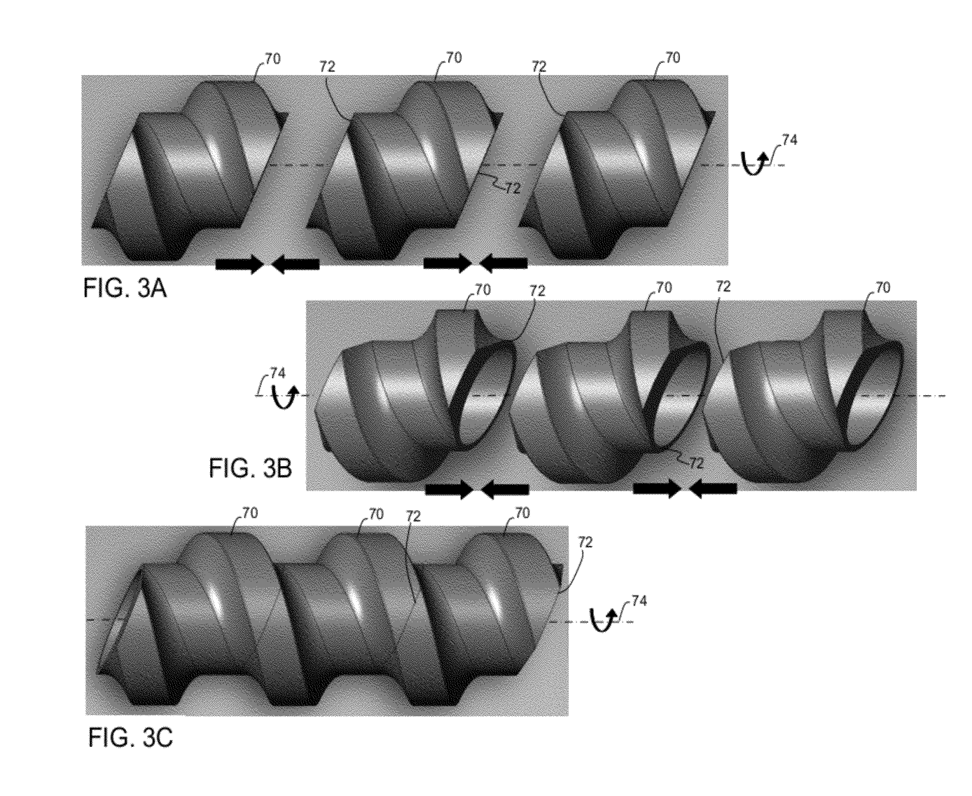

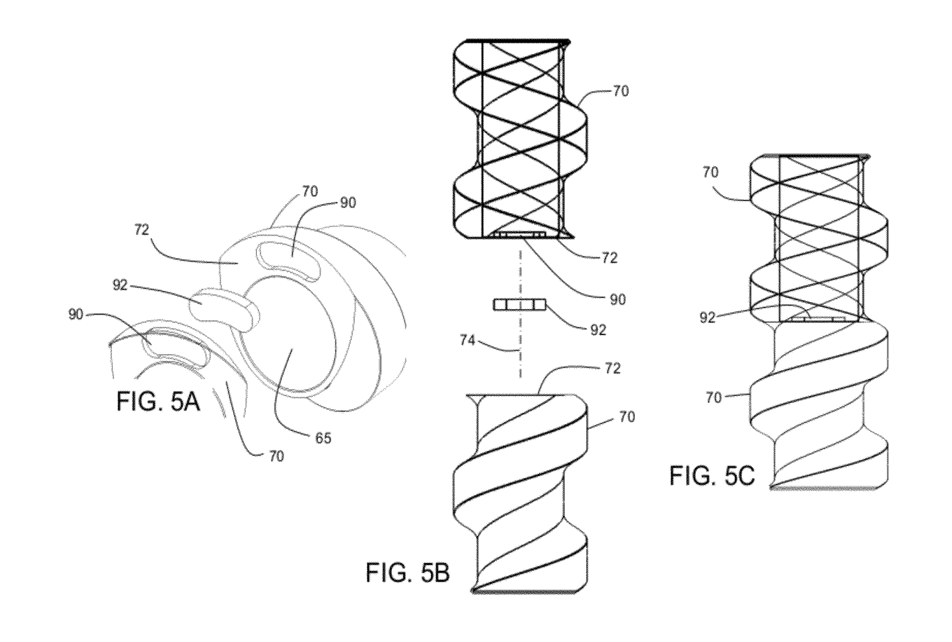

Screw segments 44, 50, 52, 54, 56 can also include various other features. For example, as shown in FIG. 2 (and also FIG. 3B and FIG. 5A), a hole 65 can be provided generally about the rotational axis of the screw segment and can extend through the length thereof to provide an interface with the drive shaft 46, 48 of a screw set 38, 40. The hole 65 can include structure 66 adapted to interface with the associated structure (e.g., spline shaft, keyway structure, etc.) of the drive shaft 46, 48. As described above, when screw segments 50, 52, 54, 56 are formed of ceramic, hole 65 comprises a circular axial opening, and structure 66 comprises a metal collar inserted and secured into the hole 65 in the ceramic outer portion by a bonding agent 67 (e.g., epoxy). The metal collar is configured to mate with the drive shaft, such as in a splined or keyed engagement. In other embodiments, the ceramic screw segment may be bonded directly to the drive shaft by bonding agent 67 without use of an intermediate splined or keyed metal collar.

Typically, bonding agent 67 will be the weakest portion of the screw set 38, 40. Because of the severe conditions experienced within an extruder during use (e.g., high temperatures, pressures, torque, and the like), the bonding agent 67 at the interface of the ceramic screw segment and metal collar 66 (or at the interface of the ceramic screw segment and drive shaft, if no metal collar is used) is subject to failure during use, such as when high temperatures or high torques exceed the capabilities (e.g., maximum operating temperature, shear strength, etc.) of the bonding agent 67. As can be appreciated, failure of bonding agent 67 can result in equipment damage or lost production time. This is especially true when extruder 20 is a twin screw extruder and precise rotational position of the screw sets 38, 40 must be maintained to avoid interference (i.e., contact) between the screws. Typically, interference between screw sets 38, 40 results in destruction of the interfering portions.

Referring to FIGS. 3A-3B, the interface of multiple screw segments 70 according to the claims is illustrated. It should be understood that screw segments 70 are representative of any of various screw segments 44, 50, 52, 54, 56 described above, and the principles and details described with respect to screw segments 70 are equally applicable to screw segments 44, 50, 52, 54, 56. For purposes of clarity, the drive shaft is not shown. Each screw segment 70 has end faces 72. In prior art screw segments, end faces 72 are perpendicular to the axial orientation of the drive shaft (e.g., perpendicular to axis 74), such that the perpendicular end faces meet but do not interact other than any small frictional forces between the end faces. In contrast, to reduce the mechanical stresses placed on bonding agent 67, screw segments 70 of the present disclosure are provided with end faces 72 that are non-orthogonal to the axial orientation of the drive shaft (e.g., non-orthogonal to axis 74). The non-orthogonal end faces 72, when brought together on the drive shaft, mechanically link adjacent screws segments 70 by creating an overlap and interlock from one screw segment 70 to the next, reducing or eliminating torsional forces being applied to bonding agent 67, and thereby reducing or eliminating the possibility that bonding agent 67 may fail. Further, even if the bonding agent 67 were to fail, the screw segment 70 would not be free to rotate about the drive shaft independent of the adjacent screw segments and the load would be distributed to the adjacent screws segments 70.

Advantageously, making end faces 72 non-orthogonal to the axial direction changes the orientation of the screw flight 76 versus the end faces 72 such that the screw flight will not have a thin edge which could be easily chipped due to the brittle nature of the ceramic material of the screw segment. Additionally, the torsional load applied by the driving mechanisms 42 is beneficially carried over a larger surface area and cross-section of the screw segment, thereby putting the ceramic material in compression where it has extremely high strength.

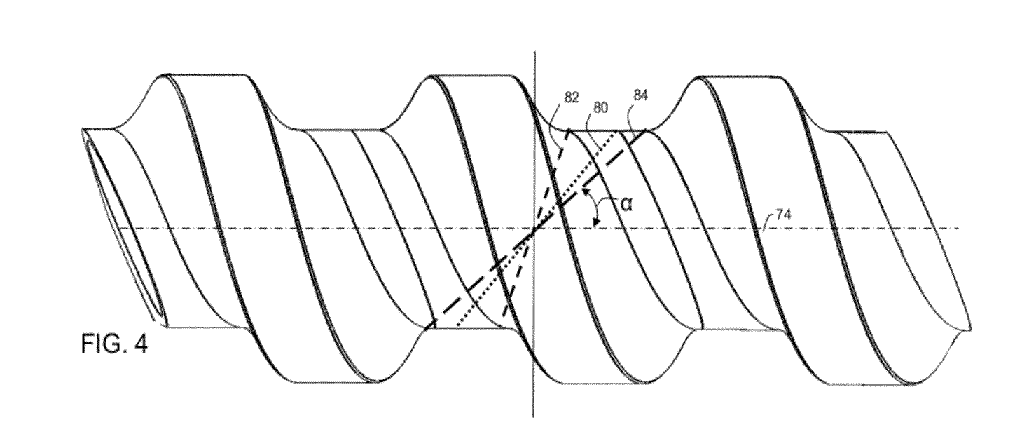

In one embodiment, end faces 72 are oriented at a non-orthogonal angle α with respect to the axis of the drive shaft. Angle α may be selected depending upon one or more factors including, but not limited to, the number of flights on the screw segment, the pitch of the flights on the screw segment, the shape and width of the crest, the shape and width of the root, the root diameter, the pitch diameter, the major diameter, the expected operating conditions of the extruder (e.g., torque, temperature, etc.) and the operating capabilities of the bonding agent 67. In one embodiment, a is between 45° and 80°. In another embodiment, α is determined by passing a line through the center of the root on one side of a crest to the center of the root on the opposite side of the crest (shown as line 80 in FIG. 4). In yet another embodiment, the largest value of α (e.g., the value nearest perpendicular to the axial direction) is determined by passing a line through the root closest to the base of one side of a crest and through the root closest to the base of the opposite side of the crest (shown as line 82 in FIG. 4). In yet another embodiment, the smallest value of α (e.g., the value furthest from perpendicular to the axial direction) is determined by passing a line through the root furthest from the base of one side of a crest and through the root furthest from the base of the opposite side of the crest (shown as line 84 in FIG. 4).

To enhance the mechanical interlock between mated screw segments 70, end faces 72 are provided with additional interlocking or frictional features. For example, in one embodiment, end faces 72 are provided with a surface texture or finish that increases friction between mated end faces 72. In another embodiment, end faces are provided with a key feature that mechanically interlocks adjacent screw segments 70. For example, referring to FIGS. 5A-5C, a pocket 90 is formed in each end face 72 to receive a mating key insert 92 during assembly of screw segments 70 onto the drive shaft. It should be noted that although FIGS. 5A-5C show end faces 72 at a substantially orthogonal angle with respect to axis 74 (e.g., a is about 90° in FIGS. 5A-5C), the use of pockets 90 and insert 92 is not so limited. Rather, pockets 90 and insert 92 may be used for end faces 72 at any angle α with respect to axis 74, such as the angles described above with respect to FIGS. 3A-3C and FIG. 4. Insert 92 can carry and distribute a load across adjacent screw segments 70 should bonding agent 67 strain or fail and thereby engage the key insert 92. The insert 92 is formed from a material, such as metal, which has sufficient compliance to evenly distribute the load across the maximum surface area of pockets 90. The strength, surface area, shape and depth of pockets 90 and insert 92 must be carefully selected such that insert 92 is strong enough to support the load, has enough surface area to avoid being sheared off, and is shaped to minimize stress concentrations, such as by rounding corners of pockets 90 and insert 92. FIGS. 5A-5C illustrate one example of how pockets 90 could be formed in end faces 72 to allow for a metallic insert 92 to be installed during installation of screw segments 70 on a drive shaft (not shown), such that pockets 90 and insert 92 utilize the most surface area possible (e.g., both surface area on faces 72 and depth of pockets 90).

Turning briefly back to FIG. 1, it is to be understood that the various mixing segments 44, 50, 52, 54, 70 discussed herein can be arranged in various orders to promoting relatively more uniform dispersive and distributive mixing of the batch material.

An example method of using the twin-screw extruder 20 for manufacturing a ceramic honeycomb green body to produce a porous honeycomb filter will now be discussed. It is to be understood that more or less, similar or different method steps can also be included.

The method can include the step of providing the barrel 22 with the pair of chambers 24, 26 formed therein in communication with each other. The barrel 22 can also include the discharge port 36 and the extrusion molding die 34 coupled with respect to the discharge port 36 of the barrel 22. The method can further include the steps of providing a plurality of screw segments 44, 50, 52, 54, 70 having end faces non-orthogonally aligned with the axial direction on drive shaft 46 to form the first screw set 38 rotatably mounted at least partially within one of the pair of chambers 24, and providing another plurality of screw segments 44, 50, 52, 54, 70 having end faces non-orthogonally aligned with the axial direction on drive shaft 48 to form the second screw set 40 rotatably mounted at least partially within the other of the pair of chambers 26. The screw sets 38, 40 can be coupled to the driving mechanism 42 directly or indirectly, such as through drive shafts 46, 48.

The method can further include the step of providing a flowable ceramic batch material into the barrel 22, such as generally along the direction of arrow I of FIG. 1 via the material supply port 32 located generally towards an upstream side 28 of the barrel 22. The batch material can be supplied generally continuously.

It will be apparent to those skilled in the art that various modifications and variations can be made in the present invention without departing from the spirit or scope of the invention. Thus, it is intended that the present invention cover the modifications and variations of this invention provided they come within the scope of the appended claims.

What is claimed is:

1. A screw set for an extruder having an axially extending drive shaft, the screw set comprising:
a plurality of screw segments, each screw segment having opposed end faces disposed at a non-orthogonal angle α with respect to a rotational axis of the screw segment;
wherein the plurality of screw segments are contiguously positioned on the drive shaft such that end faces of contiguous screw faces align and mate with each other.

2. The screw set of claim 1, each screw segment comprises at least one flight spirally formed around the segment and defining a crest and a root of the segment, and wherein the angle α of the end faces is selected based on at least one of a number of flights on the screw segment, a pitch of the flights on the screw segment, a shape and width of the crest defined by the flight, the shape and width of the root defined by the flight, a root diameter of the segment, a pitch diameter of the segment, a major diameter of the segment.

3. The screw set of claim 1, wherein the angle α is between 45° and 80°.

4. The screw set of claim 2, wherein the angle α is determined by passing a line through a center of the root on one side of the crest to a center of the root on the opposite side of the crest.

5. The screw set of claim 2, wherein a range for the value of α is defined by a first line passing through a root closest to a base of one side of a crest and through a root closest to a base of an opposite side of the crest, and a second line passing a line through the root furthest from the base of one side of the crest and through the root furthest from the base of the opposite side of the crest.

6. The screw set of claim 1, wherein at least one of the screw segments is formed of a ceramic material.

7. The screw set of claim 1, further comprising:
aligned pockets in mating faces of contiguously positioned screw segments; and
a key inserted in the pockets and extending between contiguously positioned screw segments.

8. An extruder screw segment comprising a cylindrical body having opposed end faces disposed at a non-orthogonal angle α with respect to a rotation axis of the body.

9. The extruder screw segment of claim 8, wherein the cylindrical body is formed of a ceramic material.

10. The extruder screw segment of claim 9, wherein the cylindrical body includes a generally cylindrical opening extending along the rotational axis of the body, and a cylindrical metal sleeve bonded within the opening.

11. The extruder screw segment of claim 10, wherein the cylindrical metal sleeve is configured to engage a drive shaft in a splined or keyed engagement.

12. The extruder screw segment of claim 10, wherein the cylindrical metal sleeve is bonded within the opening of the cylindrical body with an epoxy.

13. An extruder comprising:
a barrel including a chamber and a discharge port;
an extrusion molding die coupled with respect to the discharge port of the barrel; and
a screw set rotatably mounted at least partially within the chamber, wherein the screw set comprises a plurality of contiguously positioned screw segments, each screw segment having opposed end faces disposed at a non-orthogonal angle α with respect to a rotation axis of the screw set.

14. The extruder of claim 13, wherein at least one of the screw segments is formed of a ceramic material.

15. The extruder of claim 13, wherein:
the barrel includes a pair of chambers formed therein in communication with each other and the discharge port;
a first screw set rotatably mounted at least partially within one of the pair of chambers and including a first drive shaft;
a second screw set rotatably mounted in the other of the pair of chambers and including a second drive shaft generally parallel to the first drive shaft;
wherein at least one of the first and second screw set each comprise a plurality of contiguously positioned screw segments, each screw segment having opposed end faces disposed at a non-orthogonal angle α with respect to a rotation axis of the screw set.
